(19) United States
(12) Patent Application Publication
(10) Pub. No.: US 2026/0234456 A1
(43) Pub. Date: Aug. 13, 2026

(54) MICROCAPSULES

(71) Applicant: Albotherm Limited, Bristol (GB)

(72) Inventors: Siân Louise Fussell, Bristol (GB); Kayleigh Marshall, Gwent (GB); Luke Demetri, Demetri (GB)

(21) Appl. No.: 19/154,939

(22) PCT Filed: Feb. 9, 2024
(86) PCT No.: PCT/EP2024/053367

§ 371 Date: Aug. 8, 2025

(30) Foreign Application Priority Data
Feb. 9, 2023 (GB) 2301851.8

(51) Int. Cl. C09K 5/06; B01J 13/10; B01J 13/18; C09D 7/40; C09D 7/61; C09D 7/65; C09D 133/04

(52) U.S. Cl. CPC C09K 5/063; B01J 13/10; B01J 13/185; C09D 7/61; C09D 7/65; C09D 7/68; C09D 7/69; C09D 7/70; C09D 133/04

(57) ABSTRACT

The invention relates to a microcapsule comprising a shell and an internal phase, wherein said shell encapsulates said internal phase, said internal phase comprising a thermotropic polymer and a liquid medium. The invention also provides methods of making the microcapsules and products comprising the microcapsules of the invention, including coatings for glazing applications.

### TECHNICAL FIELD

This invention relates to a microcapsule comprising a thermotropic polymer and methods of making the same. The invention also provides products comprising the microcapsules of the invention, including coatings for glazing applications.

### BACKGROUND

The protection against overheating in buildings is still mainly achieved by conventional mechanical shading. The average annual worldwide consumption of energy for cooling buildings worldwide already almost exceeds the energy consumption for heating buildings. The increasing use of glass facades in architecture, including the use of organic glasses, accelerates this process increasingly. The excellent thermal insulation capabilities of today's glass facades, whereby the buildings are kept from cooling down in winter, have an energetically counter-productive effect in warm seasons. As a result, increased electric power is needed for cooling. An optimization of the energy balance is required to avoid increasing thermal stress in the cities. Accordingly, buildings must be planned so that passive cooling takes place, rather than provide them with electric air conditioning systems.

The use of thermotropic polymers has been explored in this context. Thermotropic polymers offer a temperature-dependent change in transparency, for example to visible and/or IR radiation. In particular, thermotropic polymers can switch from a relatively clear to a more light scattering state when the temperature rises. Such materials can help reduce the energy requirements of buildings. In winter, the solar heat reduces the heating energy requirement. In summer, a larger part of the solar radiation is reflected, thus reducing the cost of cooling and ventilation.

Nakamura et al, Ind. Eng. Chem. Res. 2019, 58, 16, 6424-6428 discloses the use of pNIPAM (poly(N-isopropylacrylamide)) and HPC (hydroxypropyl cellulose), known thermotropic polymers, to make smart windows. At lower temperatures, the windows allow substantially all light to pass through, whereas at hotter temperatures, some of the light is reflected, helping to reduce solar gains and regulate the internal temperature of the structure to which the smart glass is attached.

The smart windows of Nakamura et al are in the form of a hydrogel layer sandwiched between two panes of glass. This is essential because, if the thermotropic polymers dry out, they lose their temperature response.

However, providing a thermotropic polymer sandwiched between two panes of glass is not always practical due to at least size, cost and flexibility factors. Furthermore, if one of the panes of glass is damaged, then fixing the issue would require replacing the entire window structure.

In addition, WO2013/152923 discloses the use of thermotropic particles for the doping of polymer matrices. Doped polymer matrices according to the invention are employed as sun protection, for example, in the form of paints, coatings, resins, thermosets or thermoplastics. The particles contain a polymer core which is a thermotropic material, and anchor groups extending from the core. The particles are prepared by using an oil-in-water emulsion, and then polymerising the oil phase to create the particle.

There is a need in the art for a more flexible and versatile way to use thermotropic materials than the products disclosed in the prior art, particularly in sun protection and glazing applications.

### SUMMARY OF THE INVENTION

The present invention provides a microcapsule comprising a shell and an internal phase, wherein said shell encapsulates said internal phase, said internal phase comprising a thermotropic polymer and a liquid medium.

The invention also provides a plurality of microcapsules of the invention.

The invention also provides a method of producing a microcapsule, or a plurality of microcapsules, the method comprising forming a shell to encapsulate an internal phase comprising a thermotropic polymer and a liquid medium.

The invention also provides a method of producing a microcapsule(s) of the invention wherein the shell is formed from gelatin, a water-soluble anionic polymer and a crosslinking agent, the method comprising the steps of:
a) Preparing a dispersion or emulsion of the internal phase of the microcapsule(s);
b) Preparing a continuous phase comprising the gelatin, a water-soluble anionic polymer, a base and water;
c) Mixing the dispersion or emulsion with the continuous phase;
d) Adjusting the pH of the result of step c) to less than about 6, thus forming a coacervate;
e) Cooling the result of step d)
f) Crosslinking the gelatin in the result of step e) with the crosslinking agent.

The invention also provides a method of producing a microcapsule of the invention wherein the shell is formed from a UV curable resin, the method comprising the steps of:
a) Mixing together the components of the internal phase of the microcapsule(s) to provide an inner phase;
b) Mixing together the at least one compound comprising at least one carbon-carbon double bond, the radical photoinitiator and optionally an antifoaming agent to provide a middle phase;
c) Mixing together a stabilizing agent and water to provide an outer phase;
d) Flowing the inner phase through a first inlet tube and the middle phase through a second inlet tube, and subsequently combining the inner and middle phase to produce a combined stream in an intermediate tube;
e) Flowing the outer phase in a third inlet tube and subsequently combining the outer phase with the combined stream;
f) Flowing the result of step e) through an outlet tube and exposing the result of step e) to UV radiation.

Throughout the description and claims of this specification, the words “comprise” and “contain” and variations of the words, for example “comprising” and “comprises”, mean “including but not limited to”, and do not exclude other components, integers or steps. Moreover the singular encompasses the plural unless the context otherwise requires: in particular, where the indefinite article is used, the specification is to be understood as contemplating plurality as well as singularity, unless the context requires otherwise.

Preferred features of each aspect of the invention may be as described in connection with any of the other aspects. Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible.

As used herein, the term “substituted” means that the compound is substituted by one or more groups selected from —F, —Cl, —Br, —I, —OH, —NO₂, —CN, —SO₂, —CO₂H, —NH₃, —C(O) H, unsubstituted C₁₋₁₀ alkyl, unsubstituted C₂₋₁₀ alkenyl or alkynyl, unsubstituted C₅₋₁₂ aryl optionally wherein one or more of the ring carbon atoms is substituted by a heteroatom selected from S, N or O, and combinations thereof.

### BRIEF DESCRIPTION OF THE DRAWINGS

One or more embodiments of the invention will now be described, by way of example only, with reference to the accompanying drawings, in which:

FIG. 1 shows a microfluidics device for producing the microcapsules of the invention when the shell is formed from a UV curable resin.

FIG. 2 (I) shows the change in transmission as a function of temperature for a coating of the invention.

FIG. 2(II) shows images of the microcapsules of the invention at 26° C. and 32° C. at 1× (a,b) and 4× (c,d) magnification.

### DETAILED DESCRIPTION

Aspects of the invention relate to a microcapsule. The microcapsule of the invention comprises a shell and an internal phase, wherein said shell encapsulates said internal phase, said internal phase comprising a thermotropic polymer, a liquid medium, and optionally one or more additives.

### The Microcapsule

The microcapsule comprises a liquid medium. The liquid medium may be a polar liquid medium or a non-polar liquid medium.

The liquid medium may be a polar liquid medium. A measurement of polarity may be determined, for example, by dielectric constant.

Suitably, a polar liquid medium defined in this invention may be a liquid medium which has a dielectric constant at 20° C. greater than about 10, or optionally greater than about 15, or suitably even greater than about 20.

Optionally, the polar liquid medium may comprise water and/or an alcohol.

The polar liquid medium may comprise a single polar solvent, or may comprise a mixture of two or more polar solvents. The mixture of two or more polar solvents may comprise water and/or an alcohol.

The alcohol may suitably be a C₁₋₁₀ alcohol. It will be appreciated that the alcohol may be substituted by one or more —OH groups. In other words, the alcohol may have a single-OH group, two —OH groups (a diol), three —OH groups (a triol), four —OH groups (a tetraol), or five or more —OH groups (polyol). Exemplary alcohols include methanol, ethanol, propan-1-ol, propan-2-ol, 1,2-ethanediol, 1,3-propanediol, 1,4-butanediol, 1,5-pentanediol, propane-1,2,3-triol, butane-1,2,3,4-tetraol and pentane-1,2,3,4-pentol. Preferred alcohols include methanol, ethanol, 1,2-ethanediol, 1,3-propanediol, 1,5-pentanediol and propane-1,2,3-triol.

It will be appreciated that when the polar liquid medium comprises a mixture of two or more polar solvents, the polar liquid medium may comprise a mixture of two or more different polar solvents within the same class (i.e. two or more different alcohols) or it may comprise a mixture of two or more polar solvents from different classes (i.e. an alcohol and water).

Optionally, the polar liquid medium includes water.

Optionally, the polar liquid medium includes water and at least one alcohol. For example, the polar liquid medium may include water and at least one alcohol selected from methanol, ethanol, 1,2-ethanediol, 1,3-propanediol, 1,5-pentanediol and propane-1,2,3-triol and combinations thereof. Exemplary combinations include water and 1,3-propanediol, and water and propane-1,2,3-triol.

It will be appreciated that the polar liquid medium may consist essentially of, or consist of, water and/or an alcohol.

When the polar liquid medium includes water, the water may preferably be present in an amount of at least about 5 wt %, more preferably at least about 15 wt %, more preferably at least about 30% of the polar liquid medium. For example, the water may be present in an amount of from about 5% to about 95%, such as from about 20% to about 80%, e.g. from about 30% to about 70% of the polar liquid medium.

When the polar liquid medium includes an alcohol, the alcohol may preferably be present in an amount of at least about 5 wt %, more preferably at least about 15 wt %, more preferably at least about 30% of the polar liquid medium. For example, the alcohol may be present in an amount of from about 5% to about 95%, such as from about 20% to about 80%, e.g. from about 30% to about 70% of the polar liquid medium.

The liquid medium may be a non-polar liquid medium. A measurement of non-polarity of the liquid medium may be determined by its dielectric constant. For example, the non-polar liquid medium defined in this invention may be a liquid medium which has a dielectric constant less than about 10 at 20° C.

The non-polar liquid medium may comprise an oil, such as silicone oil, mineral oil, or a vegetable oil such as soybean oil, sunflower oil or coconut oil.

The liquid medium may suitably be present in an amount of at least about 5 wt % of the internal phase, such as at least about 20 wt % of the internal phase, for example at least about 50 wt % of the internal phase, e.g. at least about 70 wt % of the internal phase, for example at least about 85 wt % of the internal phase.

The thermotropic polymer used in the invention may suitably be any polymer or polymer mixture which can offer a temperature-dependent change in transparency to visible and/or IR radiation.

Suitably, the thermotropic polymer may have a different refractive index to the liquid medium and, below a phase change temperature, may be homogeneously mixed with the liquid medium, and above the phase change temperature a phase separation takes place forming domains which contain a substantial portion (e.g., at least about 40 wt %, such as at least about 60 wt %) of the thermotropic polymer or the liquid medium.

Advantageously, below the phase change temperature, the difference in refractive index between the thermotropic polymer and the liquid medium may have little to no effect, allowing a substantial portion (for example at least about 80%, such as at least about 90%, for example at least about 95%) of visible and IR radiation to pass through the internal phase of the microcapsule. At or above the phase change temperature, the difference in the refractive index of the thermotropic polymer domains and the liquid medium domains may cause a portion of the visible and IR radiation to scatter, thereby reducing the transmission of the internal phase compared to the transmission below the phase change temperature.

The term “a portion of the visible and IR radiation” means at least about 5%, such as at least about 10%, e.g. at least about 20%, for example at least about 30% of the visible and IR radiation is scattered. In other words, the transmission of visible and IR radiation by the internal phase at or above the phase change temperature reduces by about 5%, such as at least about 10%, e.g. at least about 20%, for example at least about 30% as compared to the transmission of the internal phase below the phase change temperature.

The term “visible and IR radiation” refers to radiation at a wavelength of from about 0.4 μm to about 1 mm.

It will be appreciated that the refractive index of the thermotropic polymer domains and the liquid medium domains may differ by at least about 1%, for example by at least about 7%, such as at least about 20%.

“Thermotropic and Thermochromic Polymer Based Materials for Adaptive Solar Control” (Solar Control. Materials 2010; 3 (12): 5143-5168) provides an overview of the development of some embodiments of thermotropic materials and is incorporated herein by reference.

For example, the thermotropic polymer may be an hydroxypropyl cellulose (HPC) polymer or a polyacrylamide polymer.

The polyacrylamide polymer may be obtained from the radical polymerization of at least one type of acrylamide monomer having the structure:

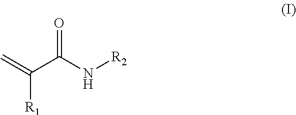

wherein:
R₁ may be H or optionally substituted C₁₋₁₀ alkyl, preferably H or methyl; and
R₂ may be optionally substituted C₁₋₁₀ alkyl, preferably methyl, ethyl, n-propyl or isopropyl, more preferably n-propyl or isopropyl.

Preferably R₁ may be H or methyl and R₂ is n-propyl or isopropyl.

Exemplary acrylamide monomers include:

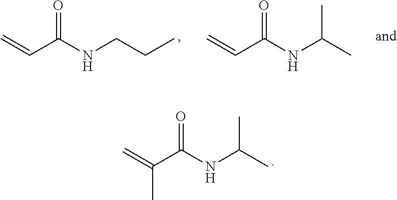

In other words, the polyacrylamide polymer may be poly(N-n-propylacrylamide) (NNPAM), poly(N-isopropylacrylamide) (NIPAM) or poly(N-isopropylmethylacrylamide) (NMPAM).

It will be appreciated that a mixture of acrylamide monomers may be used to obtain the polyacrylamide polymer. It will also be appreciated that the thermotropic polymer may be made from a mixture of different monomers, such as a combination of an acrylamide, an acrylate, a methacrylate, a vinyl acetate, and combinations thereof.

The thermotropic polymer may be a block copolymer comprising at least one block of a polyacrylamide polymer as defined above, and at least one block of a further polymer. The further polymer may suitably be selected from polyethylene glycol (PEG) and polyacrylic acid.

The thermotropic polymer may be an HPC. The HPC may be produced by reacting activated cellulose with ethylene oxide. For example, the HPC may have the structure:

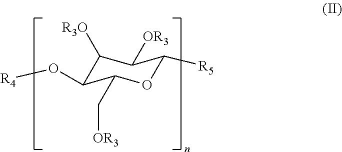

wherein:
each R₃ is independently selected from H or

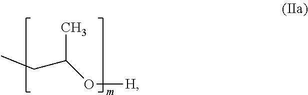

m is an integer of at least 1,
R₄ is

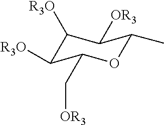

and R₅ is

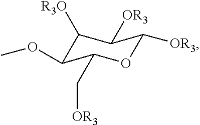

n is an integer of from about 200 to about 8000.

Suitably, the HPC has a degree of substitution (DS) value and a moles of substitution (MS) value, wherein the DS is the number of R₃ groups of formula (IIa) per repeat unit out of a maximum of 3, and wherein the MS is the average value of m per repeat unit for the polymer. Optionally, the DS may be at least 1, such as at least 2.

Optionally, the MS is at least about 2, such as at least about 2.5, for example at least about 3. Optionally, the MS is less than about 6, such as less than about 5.5, for example, less than about 5. It will be appreciated that the MS may be from about 2 to about 6, such as from about 2.5 to about 5.5, for example from about 3 to about 5.

An exemplary HPC is manufactured by Ashland under the tradename Klucel™ E-Industrial.

The thermotropic polymer may be a linear polymer or a microgel. When the thermotropic polymer is a microgel, it may be formed by chemically cross-linking a thermotropic polymer by polymerisation or by self cross-linking of a linear thermotropic polymer. A suitable method includes the method as set out in Soft Matter, Fussell et al, 2019, 15, 8578-8588, which is incorporated herein by reference.

When the thermotropic polymer is linear, it may suitably have a molecular weight of from about 40,000 to about 1,200,000 Da. When the thermotropic polymer is a linear HPC, it may suitably have a molecular weight of from about 60,000 to about 100,000 Da, such as of from about 70,000 Da to about 90,000 Da.

When the thermotropic polymer is a microgel, it may suitably have a largest diameter of from about 30 nm to about 2 μm. The largest diameter of the microgel may be measured using dynamic light scattering, wherein water may be used as a solvent and the temperature at which the measurement is taken is about 25° C.

The thermotropic polymer may be present in an amount of from about 0.1 wt % to about 30 wt %, preferably of from about 0.5 wt % to about 15 wt % of the internal phase. When the thermotropic polymer is an HPC, it may preferably be present in an amount of from about 3 wt % to about 15 wt % of the internal phase. When the thermotropic polymer is a polyacrylamide, it may preferably be present in an amount of from about 0.5 wt % to about 10 wt % of the internal phase.

The internal phase may optionally comprise one or more additives.

The one or more additives may advantageously be used to aid in the manufacture of the microcapsule of the invention.

The one or more additives may be selected from a salt, a sugar, a surfactant, an acid, a non-thermotropic polymer and combinations thereof.

Optionally, the internal phase may comprise a salt. Exemplary salts which may be used in the invention include NaCl, LiCl, KCl, KCN, MgCl₂, Mg(NO₃)₂, KNO₃, Na₂CO₃, Li₂CO₃, K₃PO₄, [(CH₃)₃NCH₂CH₂OH]Cl, (NH₄)₂SO₄ and combinations thereof. Preferably, the salt comprises NaCl.

The salt may be present in an amount of from about 0.01 wt % to about 36 wt %, preferably from about 0.5 wt % to about 15 wt % of the internal phase. The amount of salt may vary, depending on the nature of the thermotropic polymer. For example, when the thermotropic polymer is a polyacrylamide, the salt may suitably be present in an amount of from about 0.01 wt % to about 12 wt % of the internal phase, preferably from about 0.5 wt % to about 10 wt % of the internal phase. When the thermotropic polymer is hydroxypropyl cellulose HPC, the salt may suitably be present in an amount of from about 0.1 wt % to about 18 wt %, preferably from about 0.5 wt % to about 15 wt % of the internal phase.

The sugar may be a monosaccharide, a disaccharide or a polysaccharide. Examples of sugars include glucose, fructose, galactose, sucrose, lactose, maltose and cellulose. Preferably the sugar is sucrose.

The sugar, when present, may comprise at least about 0.5 wt %, such as at least about 1 wt % of the internal phase.

The organic acid may contain at least one —CO₂H group. The organic acid may be a C₁₋₁₀ organic acid. Exemplary organic acids include acetic acid and maleic acid.

The organic acid, when present, may comprise at least about 0.5 wt %, such as at least about 1 wt % of the internal phase.

The surfactant may be a poloxamer surfactant. Preferably, the poloxamer surfactant has a molecular weight of from about 2000 Da to about 10,000 Da, such as from about 4000 Da to about 8000 Da.

The surfactant, when present, may comprise at least about 0.01 wt % of the internal phase. Such as from about 0.01 wt % to about 15 wt %, such as from about 0.05 wt % to about 10 wt % of the internal phase.

The non-thermotropic polymer may be polyvinyl acetate (PVA) or polyethylene glycol (PEG). The PVA may have a molecular weight of from about 10,000 Da to about 150,000 Da, such as from about 20,000 Da to about 100,000 Da. The PEG may have a molecular weight of from about 200 Da to about 400,000 Da, such as from about 500 Da to about 400,000, for example from about 10,000 Da to about 300,000 Da, for example from about 15,000 Da to about 150,000 Da.

The non-thermotropic polymer, when present, may comprise from about 0.1 wt % to about 20 wt %, such as from about 0.5 wt % to about 12 wt % of the internal phase.

The shell may be formed from any material that forms a barrier around the encapsulated internal phase to substantially prevent the internal phase from escaping the microcapsule.

By “substantially prevent” it is meant that the weight of the microcapsule may reduce by less than about 40 wt %, such as less than about 25 wt % after exposure to air under ambient conditions (25° C., 50% relative humidity (RH)) for about 24 hours. Suitably, phase transition may still be observed visually under a microscope at up to about 4× magnification after the microcapsule has been exposed to air under ambient conditions for about 24 hours.

The shell may be formed by complex coacervation such as with gelatin, a water-soluble anionic polymer and a crosslinking agent or by a UV curable resin.

When the shell is formed from gelatin, a water-soluble anionic polymer and a crosslinking agent, the crosslinking agent may be any compound which is capable of non-reversibly linking polypeptide chains present within the gelatin.

For example, the crosslinking agent may be a compound having at least two reactive groups, such as aldehyde groups (—C(O) H), acid groups (—CO₂H), a vinyl group (—CH═CH₂), or the crosslinking agent may be a free radical photoactivated cross-linker, including for example 2-hydroxy-4′-(2-hydroxyethoxy)-2-methylpropiophenone, or it may be an optionally substituted benzophenone.

For example, the crosslinking agent may have at least two aldehyde groups and 2-10 carbon atoms which may be substituted or unsubstituted, such as a substituted or unsubstituted C₂₋₁₀ dialdehyde.

Exemplary crosslinking agents include glutaraldehyde, tannic acid and formaldehyde.

The gelatin may be porcine, bovine or piscine gelatin. Preferably, the porcine or bovine gelatin has a melting temperature of from about 30° C. to about 45° C., such as from about 35° C. to about 40° C. The piscine gelatin may have a melting temperature of from about 5° C. to about 30° C., for example from about 23° C. to about 27° C.

Exemplary water-soluble anionic polymers include gum arabic, sodium alginate, pectin, gum acacia. Preferably, the water-soluble anionic polymer comprises gum Arabic.

When the shell is formed from gelatin, a water-soluble anionic polymer and a crosslinking agent, and the liquid medium is a polar liquid medium, the internal phase additionally comprises an oil. The oil preferably comprises silicone oil, and may preferably consist essentially of or consist of silicone oil. However, it will be appreciated that the oil may comprise a hydrocarbon oil, such as a C₈₋₂₀ hydrocarbon oil. An oil is optional when the liquid medium is a non-polar liquid medium.

The silicone oil preferably has a molecular weight of from about 1000 to about 30,000 Da, more preferably of from about 5000 to about 10,000 Da.

The refractive index (RI) of the oil preferably substantially matches the refractive index of the liquid medium. By “substantially match”, the RI of the oil may preferably be within about 10%, more preferably within about 8%, more preferably within about 5%, more preferably within about 1% of the RI of the liquid medium.

It will be appreciated that when the shell is formed from gelatin, a water-soluble anionic polymer and a crosslinking agent, this provides an additional benefit for the invention because said shells are biodegradable, thus making the microcapsule a more environmentally acceptable product than shells which are non-biodegradable.

When the shell is formed from a UV curable resin, any UV curable resin may be used. The UV curable resin may comprise at least one compound comprising at least one carbon-carbon double bond and a radical photoinitiator.

The at least one compound comprising at least one carbon-carbon double bond may suitably comprise at least one acrylate group. The at least one compound comprising at least one carbon-carbon double bond may be a monomer, an oligomer, a resin or a mixture thereof.

For example, at least one compound may be an epoxy acrylate, a urethane acrylate, an acrylated silicone urethane or polyester, or an acrylated polyether.

Exemplary compounds comprising at least one carbon-carbon double bond include bisphenol A epoxy diacrylate, soybean oil epoxidized acrylate, tripropylene glycol diacrylate, methyl acrylate, ethyl acrylate, n-butyl acrylate, 2-ethyl hexyl acrylate, isodecyl acrylate, ethyl cyanoacrylate, 1,6-hexanediol diacrylate, 1,4-butanediol diacrylate, neopentylglycol diacrylate, diethylene glycol diacrylate, polyethylene glycol diacrylate, glyceryl propoxy triacrylate, trimethylolpropane triacrylate, pentaerythritol tetraacrylate and dipentaerythritol (monohydroxy) pentaacrylate.

The at least one compound comprising at least one carbon-carbon double bond may comprise at least one methacrylate group. Exemplary compounds comprising at least one carbon-carbon double bond comprising at least one methacrylate group include bisphenol A epoxy dimethacrylate, methyl methacrylate, ethyl methacrylate, butyl methacrylate, hydroxyethyl methacrylate, isodecyl methacrylate, lauryl methacrylate, lauryl tetradecyl methacrylate, 1,6-hexanediol dimethacrylate, 1,4-butanediol dimethacrylate, neopentyl glycol dimethacrylate, ethylene glycol dimethacrylate, 1,3-butylene glycol dimethacrylate and trimethylpropane trimethacrylate.

The at least one compound comprising at least one carbon-carbon double bond may be triallyl cyanurate or trimethylol propane triallyl ether.

The radical photoinitiator may be a Norrish type I, type II or polymeric photoinitiator. Exemplary radical initiators include azobisisobutyronitrile (AIBN), 1,1′-azobis(cyclohexanecarbonitrile) (ACHN), 2-hydroxy-2-methyl-1-phenylpropanone (Omnirad 1173), 2,2-dimethoxy-2-phenylacetophenone (BDK), 1-hydroxycyclohexyl-phenyl ketone (Omnirad 184), 1-[4-(2-hydroxyethoxy)-phenyl]-2-hydroxy-2-methylpropanone (Omnirad 2959), benzophenone, 4-methyl benzophenone (4MBZ), methyl benzoylformate (MBF), methyl-o-benzoylbenzoate (OMBB), di-ester of carboxymethoxy benzophenone and polytetramethylene glycol (Omnipol BP).

The shell may optionally comprise an antifoaming agent. Optionally, the antifoaming agent may be a siloxane. For example, the siloxane may be octamethylcyclotetrasiloxane or decamethylcyclopentasiloxane. The antifoaming agent may be Agitan 760 from Münzing Chemie.

The antifoaming agent, when present, may comprise from about 0.01 wt % to about 2 wt %, such as from about 0.05 wt % to about 1 wt % of the shell.

The weight ratio of the shell to the internal phase may be from about 75:25 to about 5:95, such as from about 50:50 to about 10:90.

The microcapsule may have a diameter at widest point of from about 200 nm to about 1 mm, such as from about 200 nm-200 μm, preferably from about 10-150 μm, more preferably from about 50-100 μm.

The phase change temperature of the internal phase may include a temperature of from about −20° C. to about 80° C., such as about 5° C. to about 50° C. The opacity of the internal phase below the phase change temperature is less than the opacity of the internal phase at or above the phase change temperature.

It will be appreciated that as opacity increases, transmission of visible and infrared (IR) radiation decreases and inversely as opacity decreases, transmission of visible and IR radiation increases.

The phase change temperature of the internal phase may be a single temperature or narrow range of temperatures e.g. a specific temperature ±2° C., such as ±1° C., for example ±0.5° C. It will also be appreciated that the phase change temperature of the internal phase may be a broad range of temperatures e.g. a range of about 45° C., such as a range of about 35° C., for example a range of about 25° C., e.g. a range of about 15° C., for example a range of about 5° C.

There is also provided a plurality of the microcapsules of the invention. The plurality of microcapsules may not all have the same largest diameter. Thus, the plurality of microcapsules may each have a largest diameter falling within the range of from about 200 nm to about 1 mm, such as from 200 nm to about 200 μm, preferably from about 10 to about 150 μm, more preferably from about 50 to about 100 μm.

Refractive Index (RI) may be measured using a refractometer analog Brix 0-80.

### Method of Encapsulation

The invention also provides methods of preparing the subject microcapsule(s). Different methods may be used.

The invention provides a method of producing a microcapsule, or a plurality of microcapsules, the method comprising forming a shell to encapsulate an internal phase comprising a thermotropic polymer and a liquid medium.

Suitably, the method may comprise forming the internal phase by dispersing the thermotropic polymer in a liquid medium to form an inner dispersion or emulsion.

The method may comprise forming the shell from gelatine and a crosslinking agent.

For example, the method may comprise: dispersing the internal phase in a continuous phase comprising gelatin, a water-soluble anionic polymer, a base (such as NaOH) and water to form a dispersion or emulsion in the continuous phase, preferably wherein the pH of the continuous phase is at least about 8, more preferably at least about 9; adjusting the pH of the dispersion or emulsion in the continuous phase to less than about 6, preferably to less than about 5, to form a coacervate; cooling the coacervate preferably to a temperature of between about 5° C. to about 20° C., more preferably between about 8° C. and about 18° C.; and crosslinking the gelatin in the cooled coacervate with the crosslinking agent.

Optionally, the method may comprise homogenising the dispersion or emulsion in the continuous phase, suitably by sonication or agitation.

Dispersing the internal phase in the continuous phase may comprise passing the internal phase through a membrane into the continuous phase.

When the shell is formed from gelatin and a crosslinking agent, the microcapsule(s) may be produced by complex coacervation.

Thus, the invention provides a method of producing a microcapsule(s) of the invention wherein the shell is formed from gelatin, a water-soluble anionic polymer and a crosslinking agent, the method comprising the steps of:
a) Preparing a dispersion or emulsion of the internal phase of the microcapsule(s);
b) Preparing a continuous phase comprising the gelatin, a water-soluble anionic polymer, a base and water;
c) Mixing the dispersion or emulsion with the continuous phase;
d) Adjusting the pH of the result of step c) to less than about 6, thus forming a coacervate;
e) Cooling the result of step d)
f) Crosslinking the gelatin in the result of step e) with the crosslinking agent.

The water-soluble anionic polymer forms a coacervate with the gelatin. Exemplary water-soluble anionic polymers include gum arabic, sodium alginate, pectin, gum acacia.

The base may be NaOH. Preferably, the pH of the continuous phase in step b) is at least about 8, more preferably at least about 9.

Step d) can be achieved by adding an acid to the result of step c). The acid is preferably a C₁₋₁₀ organic acid containing at least one —CO₂H group. Exemplary organic acids include acetic acid and maleic acid.

In step d), the pH of the resulting mixture may preferably be adjusted to at least about 5.

In step e), the step of cooling is preferably to a temperature of from about 5° C. to about 20° C., more preferably from about 8° C. and about 18° C.

In the crosslinking step (e.g. step f)), the crosslinking is achieved by mixing the crosslinking agent with the cooled coacervate (i.e. the result of step e)). Once the crosslinking agent has been mixed, the resulting mixture may be left for at least 2 h, such as at least 4 h, for example at least 8 h, such as at least 12 h to allow substantially all of the crosslinking agent to react. By “substantially all of the crosslinking agent”, it is meant at least about 90%, preferably at least about 95%, more preferably at least about 98% of the initial concentration of the crosslinking agent is reacted.

The size of the droplets in the dispersion or emulsion influences the size of the microcapsule(s) produced by the above method. The size of the droplets can be controlled several different ways.

For example, the emulsion or dispersion may be produced by membrane emulsification or dispersion.

Alternatively, or in addition to membrane emulsification or dispersion, the above method may optionally comprise the step of homogenizing the result of step c) before performing step d).

Sonication may optionally be performed to the result of step a) and/or after the step of homogenizing (when present). This step may help remove any entrapped air.

The method may comprise forming the shell by curing a UV curable resin.

For example, the method may comprise: dispersing the internal phase in a UV curable middle phase to form a first dispersion or emulsion; dispersing the first dispersion or emulsion in an outer phase to form a second dispersion or emulsion; and curing the middle phase to form the shell.

The method may comprise forming the middle phase by mixing together at least one compound comprising at least one carbon-carbon double bond, and a radical photoinitiator and optionally an antifoaming agent.

The method may comprise forming the outer phase by mixing together a stabilizing agent and water.

The step of curing the middle phase may involve exposing the middle phase to UV radiation.

The step of dispersing the first emulsion in the outer phase may comprise combining a stream of the first emulsion with a stream of the outer phase.

For example, the method may comprise flowing the inner phase through a first inlet tube and the middle phase through a second inlet tube, combining the inner and middle phase to provide the first dispersion or emulsion in an intermediate tube, flowing the outer phase in a third inlet tube and combining the outer phase with the first dispersion to form the second dispersion or emulsion, and flowing the second dispersion or emulsion through an outlet tube and exposing it to UV radiation.

The step of dispersing the first emulsion in the outer phase may comprise passing the first emulsion through a membrane into the outer phase.

When the shell is formed from a UV curable resin, the microcapsule may be produced by a microfluidic method.

Thus, the invention provides a method of producing a microcapsule of the invention wherein the shell is formed from a UV curable resin, the method comprising the steps of:
a) Mixing together the components of the internal phase of the microcapsule(s) to provide an inner phase;
b) Mixing together the at least one compound comprising at least one carbon-carbon double bond, the radical photoinitiator and optionally an antifoaming agent to provide a middle phase;
c) Mixing together a stabilizing agent and water to provide an outer phase;
d) Flowing the inner phase through a first inlet tube and the middle phase through a second inlet tube, and subsequently combining the inner and middle phase to produce a combined stream in an intermediate tube;
e) Flowing the outer phase in a third inlet tube and subsequently combining the outer phase with the combined stream;
f) Flowing the result of step e) through an outlet tube and exposing the result of step e) to UV radiation.

Preferably, the inner phase is provided to the first inlet tube from a first syringe. Preferably, the step of flowing the inner phase through the first inlet tube may be at a rate of about 5-50 μl/minute.

Preferably, the middle phase is provided to the second inlet tube from a second syringe. Preferably, the step of flowing the middle phase through the second inlet tube may be at a rate of about 5-100 μl/minute.

Preferably, the outer phase is provided to the third inlet tube from a third syringe. Preferably, the step of flowing the outer phase through the third inlet tube may be at a rate of about 0.5-5 ml/minute.

The stabilizing agent may be any agent which is water-soluble and increases the viscosity of water. Suitably the viscosity may be increased by at least about 1 cSt upon addition of the stabilizing agent. For example, the stabilizing agent may be polyvinyl acetate (PVA) or hydroxyethyl cellulose (HEC). The stabilizing agent may be present in an amount of from about 0.1 wt % to about 20 wt % of the outer phase.

The step of exposing to UV radiation (e.g. exposing the result of step e) to UV radiation) may be for a length of time of at least 5 minutes, such as for at least 15 minutes.

The wavelength of the UV radiation is between about 100-400 nm. Preferably the UV radiation is UVB radiation (namely a wavelength of between about 280-315 nm).

For all methods set out above, the resulting microcapsules may be extracted by centrifuging. Optionally, the centrifuged microcapsules may be washed with deionized water and then subsequently filtered and/or dried.

### Applications

The microcapsule(s) of the invention may be used in glazing applications or indeed other applications where thermal regulation is beneficial or desirable.

For example, the plurality of microcapsules of the invention may be applied to any external surface of a structure. A structure may be a greenhouse, a polytunnel, a building (such as a residential building, a commercial building, an industrial building or a combination thereof), a vehicle (such as a car, a bus, a lorry or truck, a railed vehicle, an aircraft, or a watercraft), or a solar panel.

The surface may be a roof or a wall or glass, e.g. a pane of glass.

The surface may be part of an existing structure. Alternatively, the plurality of microcapsules of the invention may be applied to the surface prior to the surface being added to a structure.

The term “glass” encompasses silicate glass as well as polycarbonate glass and includes architectural glass, marine glass and automotive glass. It will be appreciated that when the surface is a glass, the microcapsules of the invention may be applied to the internal surface of the glass, or the microcapsules may be included within the glass, such as an interlayer.

The plurality of microcapsules of the invention may be applied as part of a coating.

Thus, the invention provides a coating comprising a plurality of the microcapsules of the invention. The durability of the plurality of microcapsules advantageously allows a coating to be applied in a variety of different ways. It will be appreciated that the coating may be applied to a surface, for example, to glass or a polytunnel. As set out above, it may be applied to the surface when the glass is part of an existing structure, or prior to the surface being added to a structure.

The coating may be a paint, such as a water-based paint, a solvent-based paint or an oil-based paint. When the coating is a paint, the plurality of microparticles of the invention may be physically mixed with the components of the paint during manufacture of the paint or prior to application of the paint.

The coating may be a film, such as a plastic film. The plastic film may comprise a polyethylene terephthalate (PET), a polyether polyurethane, an ethylene tetrafluoroethylene (ETFE), a polyacrylate, a polyester, and combinations thereof. Optionally the film has a visible light transmittance (%) of at least about 60%, such as at least about 70%, for example at least about 80% as measured in accordance with ASTM D1003 when tested below the phase change temperature of the microparticles of the invention.

When the coating is a film, the plurality of microcapsules of the invention may be added to the film before, during or after manufacture of the film. For example, when the film is a plastic film, the film may be produced by extrusion, and the plurality of microcapsules of the invention may be added to the plastic film prior to, during or after extrusion of the plastic film.

It will be appreciated that if the plurality of microcapsules of the invention are added to the film before or during manufacture, the microcapsules may be embedded at least in part in the film.

If the plurality of microcapsules of the invention are added to the film after manufacture, the microcapsules may be applied to the surface of the film, for example, using an adhesive.

The coating may be applied as a spray coating. For example, the spray coating may be applied using a pressurized liquid stream.

The coating may be a solar panel coating. For example, the microcapsules of the invention may be included in a self-cleaning solar panel coating.

Alternatively, the plurality of microcapsules of the invention may be added to a glass interlayer. The glass interlayer may comprise a polyvinyl butyral (PVB), an ethylene vinyl acetate (EVA), an ionoplast, and combinations thereof.

Preferably the coating or interlayer comprises at least about 0.2 wt % of the plurality of microcapsules of the invention, for example from about 0.2 wt % to about 50 wt % of the total weight of the coating or interlayer.

It will be appreciated that the plurality of microcapsules of the invention, and the surface, glass, interlayer and/or coating of the invention may be used as sun protection. It will also be appreciated that the plurality of microcapsules of the invention, and the surface, glass, interlayer and/or coating of the invention may be used for passive cooling.

### EXAMPLES

### Example 1—Preparation of Microcapsules with Shells Formed from a UV Curable Resin

### Materials

Klucel E-Industrial HPC (Ashland), 1,3 propanediol (PDO) (Grantrade), NaCl (Sigma Aldrich), Poly vinyl alcohol (PVA) (87-90% hydrolyzed, average mol wt 30,000-70,000) (Sigma Aldrich), Miramer PU2560 (50 wt %, Miwon), tripropylene glycol diacrylate—TPGDA (19.2 wt %, Qualipoly), isodecyl acrylate-IDA (19.2 wt %, Qualipoly), methyl benzoylformate—MBF (5 wt %, IGM), 2-hydroxy-2-methyl-1-phenylpropanone—Omnirad 1173 (5 wt %, IGM) and Agitan760 (0.2 wt %, Munzing), female and male luers ( 1/16 inch, Amazon), Silicon tubing 1.5 mm inner diameter (Amazon), Needles (Amazon, Somerset solders). All chemicals were used without further purification.

### Microfluidics Device

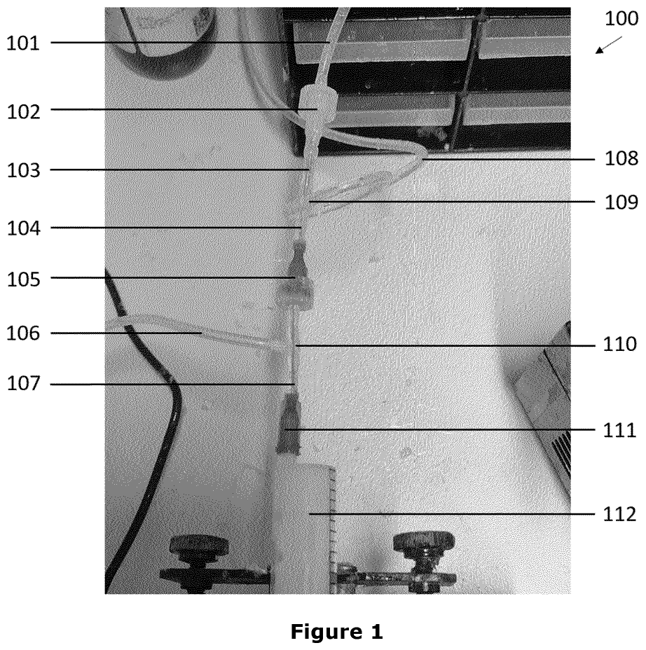

FIG. 1 shows a microfluidics device (100) which may be used to produce the microcapsule of the invention.

The microfluidic device (100) was built using readily available materials including polypropylene male (102, 105) and female luer fitting, a cross junction (109) and a tee-link (110), as well as stainless steel dispensing needles (103, 104, 107) and silicone tubing (e.g. 106, 108). The needle gauges used for the inner phase was 25 gauge 1.5 inch needle (107) for the tee-junction, a 25 gauge ½ inch needle (104) and a 20 gauge ½ inch needle (103) for the cross junction. The middle phase was introduced from the syringe via female luer into the silicone tubing (106) connected at the tee junction (110). The outer phase was introduced from the syringe via a 15 gauge 1.5 inch dispensing needle into a silicone tube (108) which was split by a tee junction to two silicone tubes which attach to the cross junction (109) of the microfluidic device.

The device was cleaned with DI water and primed with the outer phase before use.

### Method for Microcapsule Formation

Inner phase: 7 wt % NaCl, 27 wt % PDO and 66 wt % HPC solution of a 20 wt % HPC dissolved in water was stirred using a magnetic stirrer for 12 h.

Middle phase: Miramer PU2560 (50 wt %), tripropylene glycol diacrylate—TPGDA (19.2 wt %), isodecyl acrylate—IDA (19.2 wt % Qualipoly), methyl benzoylformate—MBF (5 wt %), 2-hydroxy-2-methyl-1-phenylpropanone—Omnirad 1173 (5 wt %) and Agitan760 (0.2 wt %) were mixed together.

Outer phase: A 10% PVA solution was produced by adding boiling deionised (DI) water to PVA powder and stirred.

The phases were then added to a first, second and third syringe respectively and attached to the microfluidic device. The flow rates used were inner phase (35 microliter/minute), middle phase (20 microliter/minute) and outer phase (1.5 ml/minute).

The outlet tube (101) was passed over a UV lamp, with wavelength (302 nm) and then cured under a UV-LED lamp (365 nm+405 nm) for 15 minutes.

The resulting microcapsules were then centrifuged and washed with DI water before filtering and drying.

### Example 2—Preparation of Microcapsules with Shells Formed from Gelatin and a Crosslinking Agent

### Materials

Silicone oil (100 cP) (PMX200, Dow Corning), 1,3-propanediol PDO (40 wt % in water) (Gantrade), pNIPAM (2.4 wt % in water), Dowsil 5525C surfactant (Dow corning), porcine gelatin (Weishardt, 280 Bloom, 20 mesh), gum Arabic (Nexira, Instagum AA, Food grade/Halaal/Kosher), acetic acid (20 wt % in water, Sigma Aldrich), glutaraldehyde (50 wt % in water, Sigma Aldrich).

### Method of Microencapsulation

Emulsion Phase: A solution of silicone oil (100 cP) with 2% w/w Dowsil 5525C surfactant was prepared via stirring and heating to 30° C.

The emulsion phase was produced by homogenising 9.6 g of the silicone oil solution with an Ultraturrax T25 homogeniser at 10,000 rpm whilst adding 6.4 g of a solution of 60% pNIPAM in water with 40% 1,3-PDO dropwise over 1 minute. Homogenising was continued for another 2 minutes.

The resulting emulsion phase was sonicated in a sonication bath for 3 minutes for deaeration and then charged to a syringe connected to an LDC-1 dispersion cell (Micropore Technologies), containing a stirrer and a dispersion membrane.

Continuous phase: 350 mL of deionised water was heated to 45° C. with stirring. Gum arabic (1.43 wt %) was added, followed by the porcine gelatine (1.43 wt %). When a homogenous solution was formed, 4M NaOH was added dropwise until a pH of 9 was reached. 100 ml of the resulting continuous phase was added to the LDC cell. The stirrer was activated.

The LDC stirring cell quickly became turbid as the emulsion phase was added. No membrane blockage occurred. When addition of 10 ml of the emulsion phase was completed, the resulting product was decanted to a beaker holding the rest of the continuous phase, held at 40° C., stirred by an overhead stirrer at low RPM (100-150 RPM).

Acetic acid was then added dropwise until the solution reached a pH of 4.7. The solution had become additionally turbid as the pH change induced coacervate formation. The solution was then allowed to cool to 20° C. Walls formed on the capsules at this point, which were then further cooled to 15° C. and crosslinked with 1.5 g of glutaraldehyde (50%).

### Example 3—Production and Analysis of Coating Containing Microcapsules of the Invention

A water based coating was prepared from a mixture of acrylic co-polymer dispersion (EPS 564, 64 wt %), polyurethane dispersion (Tego Variplus DS50, 30 wt %), antifoam (Tego Foamex 24, 0.1 wt %), wetting and dispersing agents (Dyno Add F-608, 0.5 wt % and Valida S231C, 3.5 wt % respectively), rheology modifier (Tafigel PUR48, 0.3 wt %) and water (2 wt %). 20 wt % microcapsules produced by Example 1 were added to the prepared coating and gently stirred.

The coating was applied to a 10×10 cm glass substrate by flood coating and allowed to dry for 2 hours in ambient conditions (approximately 25° C., 30% relative humidity) before measuring the opacity at varying temperatures.

The opacity of the coating was measured using a light box with a lux meter heated externally by an IR lamp to measure the transmission of the coatings at different temperatures and record the temperature where a drop in transmission occurred.

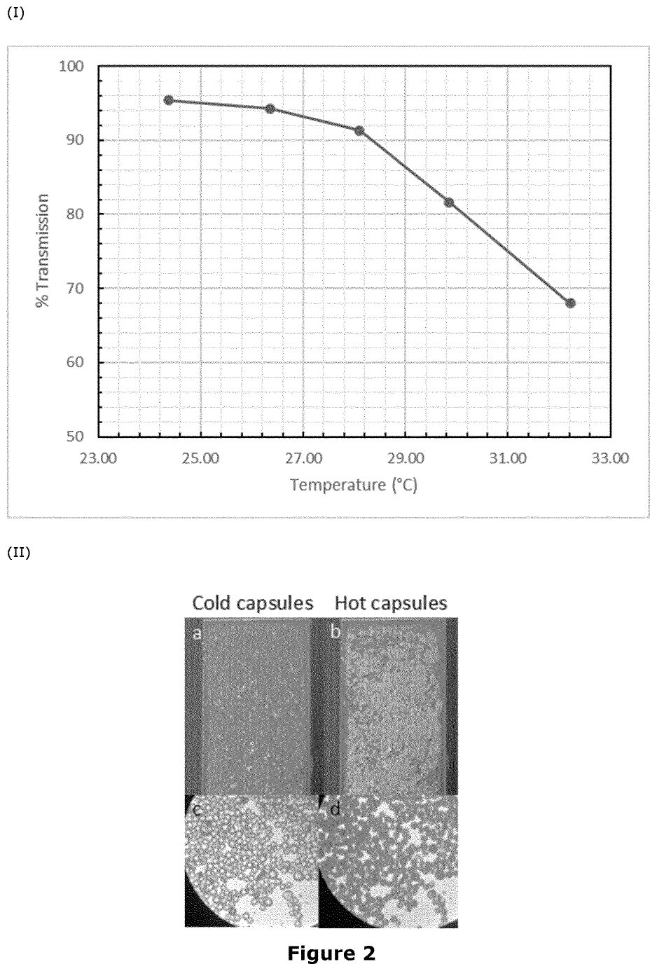

The results of the transmission testing are shown in FIG. 2(I). The graph demonstrates that the transmission of the coating decreases from about 95% at 26° C. to about 68% at 32° C.

### Example 4—Analysis of Microcapsules Produced in Example 1

The microcapsules produced in Example 1 were analysed visually at 26° C. and 32° C. The results are shown in FIG. 2 (II).

Images a and b are images of the microcapsules at 1× magnification. Image a shows the microcapsules at 26° C. and image b shows the microcapsules at 32° C. It can be seen from a simple visual inspection that the opacity of the microcapsules increases from 26° C. to 32° C.

Images c and d are images of the microcapsules at 4× magnification. Image c shows the microcapsules at 26° C. and image d shows the microcapsules at 32° C. It can be seen from a simple visual inspection that the opacity of the microcapsules increases from 26° C. to 32° C.

### Example 5—Preparation of Microcapsules with Shells Formed from a UV Curable Resin

### Materials

Klucel E-Industrial HPC (Ashland), 1,3 propanediol (PDO) (Fisher Scientific), NaCl (Sigma Aldrich), Poly vinyl alcohol (PVA) (87-90% hydrolyzed, average mol wt 30,000-70,000) (Sigma Aldrich), Gylcerol (Fisher Scientific), Soybean oil, epoxidized acrylate (ESBOA) (IGM), Poly(ethylene glycol) diacrylate, (PEGDA) (average Mn 200) (IGM), methyl benzoylformate (MBF) (Sigma Aldrich).

### Method of Microencapsulation

Inner phase: 7 wt % NaCl, 27 wt % PDO and 66 wt % HPC solution of a 20 wt % HPC dissolved in water were stirred using a magnetic stirrer for 12 h.

Middle phase: 47.5 wt % ESBOA, 47.5 wt % PEGDA and 5 wt % MBF were stirred using a magnetic stirrer to form a homogenous mixture.

Emulsion phase: The inner phase and outer phase were then emulsified, by adding the inner phase through 18-gauge needle at a rate of approximately 5 ml/min at a stirrer speed of 2500 rpm.

The resulting emulsion phase was then charged to a syringe connected to an LDC-1 dispersion cell (Micropore Technologies), containing a stirrer and a dispersion membrane.

Continuous phase: 35 wt % deionised water, 20 wt % of a 10 wt % solution of PVA in water, 7 wt % NaCl and 38 wt % glycerol were mixed using an overhead stirrer until a homogenous solution was formed. 70 mL of the resulting continuous phase was added to the LCD-1 cell. The stirrer was activated.

The LDC stirring cell quickly became turbid as the emulsion phase was added. No membrane blockage occurred. When addition of 30 mL of the emulsion phase was completed, the resulting product was decanted to a beaker and then cured under a UV-LED lamp (365 nm+405 nm) for 30 minutes.

The resulting microcapsules were then centrifuged and washed with DI water before filtering and drying.

1. A microcapsule comprising a shell and an internal phase, wherein said shell encapsulates said internal phase, said internal phase comprising a thermotropic polymer and a liquid medium, and wherein the internal phase has a phase change temperature and wherein opacity of the internal phase below the phase change temperature is less than the opacity of the internal phase at or above the phase change temperature.

2. The microcapsule of claim 1, wherein the liquid medium is a polar liquid medium.

3. The microcapsule of claim 2, wherein the polar liquid medium includes water in an amount of at least about 5 wt %, at least about 15 wt %, or at least about 30% of the polar liquid medium.

4. The microcapsule of claim 2, wherein the polar liquid medium includes an alcohol in an amount of at least about 5 wt %, at least about 15 wt %, or at least about 30% of the polar liquid medium.

5. The microcapsule of claim 1, wherein said thermotropic polymer is a hydroxypropyl cellulose (HPC) polymer or a polyacrylamide polymer.

6. The microcapsule of claim 5, wherein said polyacrylamide polymer is obtained from the radical polymerization of an acrylamide monomer having the structure: 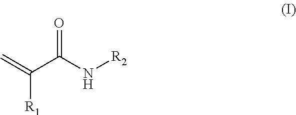
Wherein:
R₁ is H or optionally substituted C₁₋₁₀ alkyl; and
R₂ is optionally substituted C₁₋₁₀ alkyl.

7. The microcapsule of claim 6, wherein R₁ is H or methyl and R₂ is n-propyl or isopropyl.

8. The microcapsule of claim 5, wherein said polyacrylamide polymer is poly(N-n-propylacrylamide) (NNPAM), poly(N-isopropylacrylamide) (NIPAM) or poly(N-isopropylmethylacrylamide) (NMPAM).

9. The microcapsule of claim 5 wherein the hydroxypropyl cellulose polymer has the structure of formula (II): 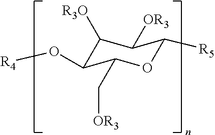
wherein:
Each R₃ is independently selected from H or 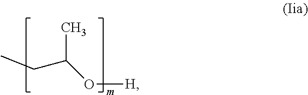
m is an integer of at least 1,
R₄ is 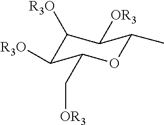
and R₅ is 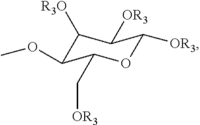
n is an integer of from about 200 to about 8000.

10. The microcapsule of claim 1, wherein said thermotropic polymer is present in an amount of from about 0.1 wt % to about 30 wt % of the internal phase.

11. (canceled)

12. The microcapsule of claim 1, wherein said phase change temperature includes a temperature of from about 5° C. to about 50° C.

13. The microcapsule of claim 1, wherein said internal phase comprises one or more additives selected from a salt, a sugar, a surfactant, a non-thermotropic polymer and combinations thereof.

14. The microcapsule of claim 13, wherein the salt is selected from NaCl, LiCl, KCl, KCN, MgCl₂, Mg(NO₃)₂, KNO₃, Na₂CO₃, Li₂CO₃, K₃PO₄, [(CH₃)₃NCH₂CH₂OH]Cl, (NH₄)₂SO₄ and combinations thereof.

15. (canceled)

16. The microcapsule of claim 1, wherein said shell is formed by complex coacervation such as from gelatin and a water-soluble anionic polymer and a crosslinking agent, or by a UV curable resin.

17. (canceled)

18. (canceled)

19. The microcapsule of claim 16, wherein said liquid medium is a polar liquid medium and said internal phase comprises an oil, wherein said oil has a refractive index (RI) within about 10 of the RI of the polar liquid medium.

20. The microcapsule of claim 16, wherein said UV curable resin comprises at least one compound comprising at least one carbon-carbon double bond, and a radical photoinitiator.

21. (canceled)

22. The microcapsule of claim 1, wherein said microcapsule has a diameter at widest point of from about 200 nm to about 1 mm.

23.-41. (canceled)

42. A coating comprising a plurality of microcapsules as defined in claim 1.

43. (canceled)

44. (canceled)

45. (canceled)

46. A method of using a plurality of microcapsules as defined in claim 1, the method comprising applying the plurality of microcapsules to an external surface, an internal surface, or an interlayer of a glass, wherein the plurality of microcapsules promote passive cooling.

47. The coating of claim 42, wherein the coating is a paint or a film.
